(19) United States
(12) Patent Application Publication
(10) Pub. No.: US 2005/0000258 A1
(43) Pub. Date: Jan. 6, 2005

(54) Furniture drawer lock

(75) Inventor: Adelino Mioti, Caxias do Sul/RS (BR)

Correspondence Address: OSTROLENK FABER GERB & SOFFEN, 1180 AVENUE OF THE AMERICAS, NEW YORK, NY, 100368403, US

(73) Assignee: Soprano Eletrometalurgica e Hidraulica Ltda.

(21) Appl. No.: 10/870,485

(22) Filed: Jun. 16, 2004

(30) Foreign Application Priority Data
Jun. 17, 2003 (BR) MU8301152-8

(51) Int. Cl. E05B 65/44

(52) U.S. Cl. 70/78

(57) ABSTRACT

A lock for furniture drawers that provides simultaneous constraint of all the drawers and the opening liberation of only one drawer at a time thereby avoiding the tipping of furniture. The lock includes an espagnolette cam lock with a cylinder set in motion by a key. The lock is centrally placed on the superior drawer of the furniture, which mechanism is inlaid on the escutcheons of the drawer and internally protected by a second escutcheons. Internally, the espagnolette cam lock has a system of suitable gears, which rotate a connecting rod to raise an extreme pin. The movement of the pin in the interior of the piece with a slot attached to a side bar, makes the side bar rise, forcing the closing of the other drawers. The side bar is mounted, preferentially in the interior of a narrow channel, excavated in the side wall of the furniture. The side bar ha a pin for each drawer. This pin dislocates itself in the interior of a jam piece with a narrow channel in ramp, fixed in the side of each of the drawers, comes up against the respective jams, and blocks the drawers advance.

### BACKGROUND OF THE INVENTION

The present invention relates to locks for furniture drawers, and more particularly to an improved system for simultaneously locking all drawers and permitting the opening of only one drawer at a time, avoiding tipping of the furniture.

Furniture having drawers, as presently known, has a lock mechanism placed in the side or centrally in the drawer. These known systems present a first inconvenience which is they take up internal space of the drawers, which must be lowered superior or laterally, in order to place a fixed crosspiece where the tongue-piece penetrates to form the drawer movement block.

Another inconvenience in this kind of furniture is that it is not possible to have a simultaneous lock of the openings of all drawers. Usually, the block occurs only on that drawer where the locking mechanism is installed.

Yet another inconvenience of the conventional systems of locking drawers is that once the system is unlocked, all the drawers may open simultaneously, which can cause the furniture to tip when there are heavy loads inside the drawers.

An additional inconvenience of the conventional systems of closing furniture drawers is that the mechanisms are exposed internally, which can result in hooking on an object inside the drawers.

### SUMMARY OF THE INVENTION

Accordingly, it is an object of the present invention to provide a new construction of locks for furniture drawers, that overcomes the limitations of the prior art. This is achieved by a espagnolette cam lock, centrally positioned on the superior drawer of the furniture, which mechanism is inlaid in the interior of the escutcheons of the drawer and protected by an interior. From the espagnolette cam lock a connecting rod projects sideways, and is rotatable by the key's lock movement to make a pin lift up. The translational movement of the interior pin of a jamb piece with a rip, attached to a side bar, causes raising, demanding the closing of the other drawers. The side bar has a pin for each drawer that dislocates itself in the interior of a piece with a narrow channel formed with a ramp, fixed in the side of each of the drawers. A lock piece controls the vertical movement of the side bar, so that when one of the drawers is opened, the side bar is raised, provoking that the other pins on the side bar to come up against the pieces with the rip in the ramp of the other drawers, obstructing its advance forwards.

The new lock for furniture drawers of the present invention results in the following functional improvement over the conventional mechanisms:

The lock is fixed on the drawer, but it is invisible because it is inlaid between two escutcheons that prevent objects inside the drawers from being hooked in the mechanism.

It permits the safe closing of all the drawers simultaneously, via a side bar, so that pins are raised by action of the key which raises the side bar, colliding with the jamb piece and blocking the drawers advance.

It offers a system which liberates one drawer at a time, because the drawer which is open raises the pin of the bar while passing by the narrow channel in the ramp of the fixed piece on the drawer, provoking the collision of the other pins of the bar with the jamb piece of the other drawers.

The lock mechanism is appropriate for being placed in the center of the drawers, which is the most appropriate place for user manipulation.

Avoids the need for a superior crosspiece fixed to the drawer. Because it doesn't have a constraint tongue-piece, a larger internal space for the drawers is formed.

The locking system may be applied in one or two sides of the drawers without harm to the mechanism efficiency.

For a more complete understanding of the furniture drawer lock of the present invention, reference is made to the following detailed description and accompanying drawings in which the presently preferred embodiments of the invention are illustrated by way of example. That the invention may be embodied in several forms without departing from the spirit or essential characteristics thereof, it is expressly understood that the drawings are for purposes of illustration and description only, and are not intended as a definition of the limits of the invention. Throughout the following description and drawings, identical reference numbers refer to the same component throughout the several views.

### BRIEF DESCRIPTION OF THE DRAWINGS

FIG. 1 is an opened isometric view of the lock applied in a drawer;

FIG. 2 is a side view showing the mechanism of the lock opened; and

FIG. 3 is a side view showing the mechanism of the lock closed.

### DETAILED DESCRIPTION OF PREFERRED EMBODIMENTS

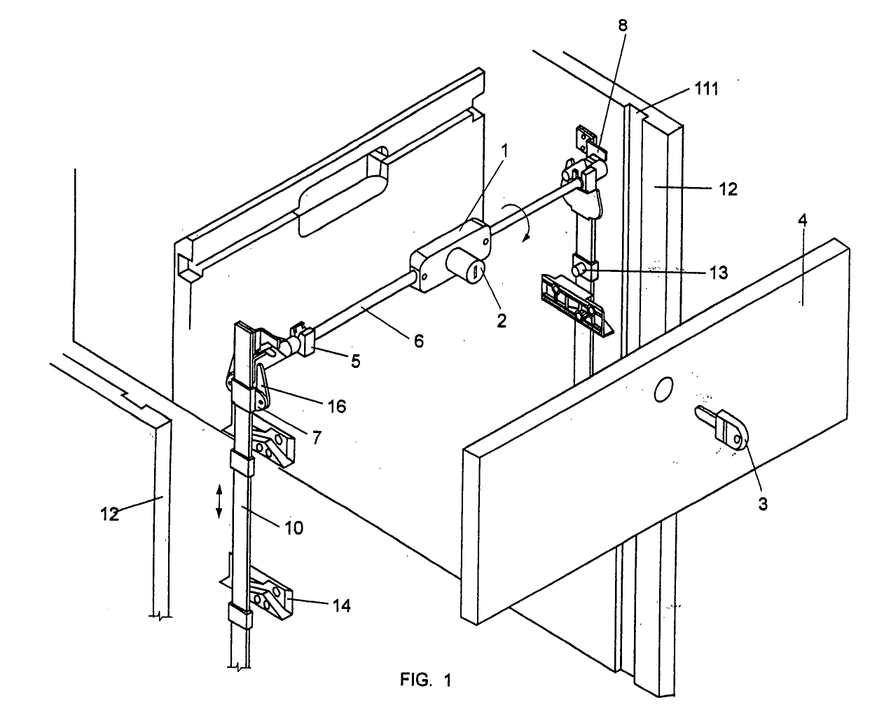

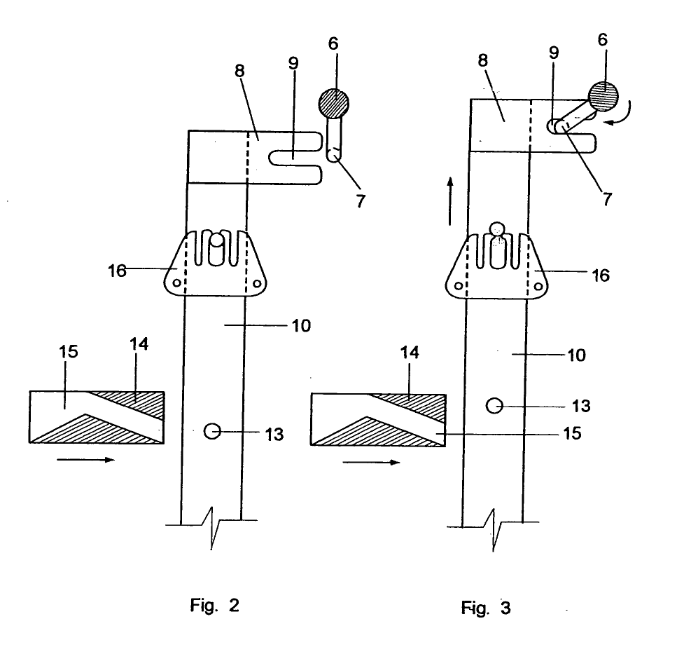

FIGS. 1 to 3 show the inventive lock, which includes an espagnolette cam lock 1 with a cylinder 2 operated by a key 3. The lock 1 is placed centrally on the superior drawers of the furniture, which mechanism is inlaid on the escutcheons 4 of the drawers and internally protected by an internal escutcheon 5.

Internally, the espagnolette cam lock 1 has a system of gears appropriate to rotate a connecting rod 6 for raising an extreme pin 7. The translational movement of the pin 7 in the interior of a piece with a slot attached to a side bar 10 causes the side bar to be raised, forcing the other drawers to be locked.

The side bar 10 is mounted, preferentially, in the interior of a narrow groove 11 on the side wall 12 of the furniture. The side bar 10 has a pin 13 for each of the drawers. This pin 13 dislocates in the interior of ajamb piece 14 with a narrow channel formed as a ramp 15. The ramp makes the other pins 13 of the side bar 10, corresponding to each of the drawers, come up against one of the respective jams 14, blocking the drawers' advance.

The system achieves additional stability from a constraint 16 that prevents the side bar 10 from dropping down due to gravity, but only when the opened drawer is closed again. Thus, when the drawer is closed, the pin passes by the narrow channel in the ramp 15, turning down the side bar 10 and unlocking automatically the other drawers.

Obviously, the side bars 10 may be mounted on one or both sides of the drawers, without altering the best functioning of the present utility model.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A lock mechanism for furniture drawers, comprising:
a lock cylinder;
a key for moving the cylinder;
a connecting rod;
an espagnolette cam lock operatively connected to the cylinder and having a system of gears which makes the connecting rod rotate, the cylinder, the cam lock and the connecting rod being inlaid in an escutcheon of the drawer and internally protected by an internal escutcheon;
a piece with a slot attached to a side bar that is vertically movable demanding closure of other drawers, the side bar having a pin for each drawer, which dislocates in an interior of a jamb piece having a narrow channel formed as a ramp and fixed in a side of each of the drawers; and
a constraint piece configured and arranged to control rising movement of the side bar, caused by the narrow channel in the ramp, during opening of one of the drawers.

2. The lock mechanism according to claim 1, wherein the lock cylinder is centrally place don a superior drawer of the furniture.
